(19) United States
(12) Patent Application Publication
(10) Pub. No.: US 2008/0302480 A1
(43) Pub. Date: Dec. 11, 2008

(54) METHOD AND APPARATUS FOR USING TAPES TO REMOVE MATERIALS FROM SUBSTRATE SURFACES

(76) Inventor: Michael A. Berger, Palo Alto, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/759,509

(22) Filed: Jun. 7, 2007

(51) Int. Cl. B32B 38/10

(52) U.S. Cl. 156/344; 156/584

(57) ABSTRACT

To peel some material (120) off a substrate (110), a shaft (720) pushes on a peeling tape (130) to unwind the peeling tape from the tape supply (320). An end effector (820) holds the substrate (110) on top of the peeling tape's section above the shaft. The peeling tape becomes bonded to the material (120). The shaft withdraws, and the peeling tape collector (330) pulls on the peeling tape to peel the tape together with the material (120).

### BACKGROUND OF THE INVENTION

The present invention relates to removing a material from a substrate's surface. Some embodiments relate to peeling an adhesive material, e.g. an adhesive tape, from a substrate's surface in fabrication of integrated circuits.

Tapes are used in fabrication of integrated circuits to protect a surface of a semiconductor wafer, and also as a means to attach a wafer to a carrier, or as dicing tapes for holding the chips in position when the wafer is diced, and for other purposes. These tapes are later removed. FIG. 1 illustrates a substrate 110 containing a semiconductor wafer, with an adhesive tape 120 covering the substrate's top surface. Tape 120 can be peeled off by depositing a peeling tape 130 adhering to tape 120, and then peeling off the tape 130 (FIG. 2) together with tape 120.

To avoid bending the substrate 110 in the peeling operation (and thus to facilitate separation of tape 130 from the substrate and avoid substrate damage) the bending In order for the peeling process to be effective, it is desirable to pull the tape 130 in a direction forming an acute angle a (i.e. a less than 90°) with the substrate's surface covered by the tape. This can be achieved, for example, as described in European patent application EP 1 760 773 A1 (Lintec Corporation), published on Mar. 7, 2007. Substrate 110 is placed on a table 310 (FIG. 3). Substrate 110 includes a semiconductor wafer with an adhesive on top (the adhesive is not shown separately). Tape 120 is a protective liner covering the adhesive, and the peeling tape 130 is used to strip the protective liner. The peeling tape is supplied from a supply roll 320 and collected in a take-up roll 330. Supply roll 320 is rotated by a motor 320M, and take-up roll 330 by a motor 330M. Tape guiding devices (not shown) are provided to guide the tape between the supply and take-up rolls.

A roller 340 presses down on peeling tape 130. Motor 320M unwinds the peeling tape from the supply roll, and roller 340 moves across the substrate 110 to spread the peeling tape over the substrate (FIG. 4). Then the roller 340 moves back (FIG. 5), and the motor 320M synchronously winds the peeling tape 130 back onto the supply roll 320 to peel the tape 120 off the substrate. The angle a (FIG. 2) appears to be about 90° in this operation. Then the peeling tape direction is reversed (FIG. 6) as motor 330M collects the peeling tape 130 onto take-up roll 330.

### SUMMARY

This section summarizes some features of the invention. Other features are described in the subsequent sections. The invention is defined by the appended claims which are incorporated into this section by reference.

Some embodiments of the present invention eliminate the need to wind the peeling tape 130 back onto the supply roll 320 during peeling. For example, in some embodiments, at the stage of FIG. 4 the substrate 110 is positioned above peeling tape 130, with tape 120 in contact with the peeling tape. When roller 340 is being withdrawn, the peeling tape 130 is pulled by take-up roll 330. The angle a (FIG. 2) is acute due to the substrate position.

In some embodiments, the substrate is held in an end effector throughout the peeling operation.

In some embodiments, supply-side motor 320M is omitted. Supply roll 320 is unwound when roller 340 pushes on peeling tape 130.

Other embodiments of the invention are described below. The invention is defined by the appended claims, which are incorporated into this section by reference.

### BRIEF DESCRIPTION OF THE DRAWINGS

FIGS. 1 and 2 are side views of a substrate with a peeling tape at different stages of a prior art peeling operation.

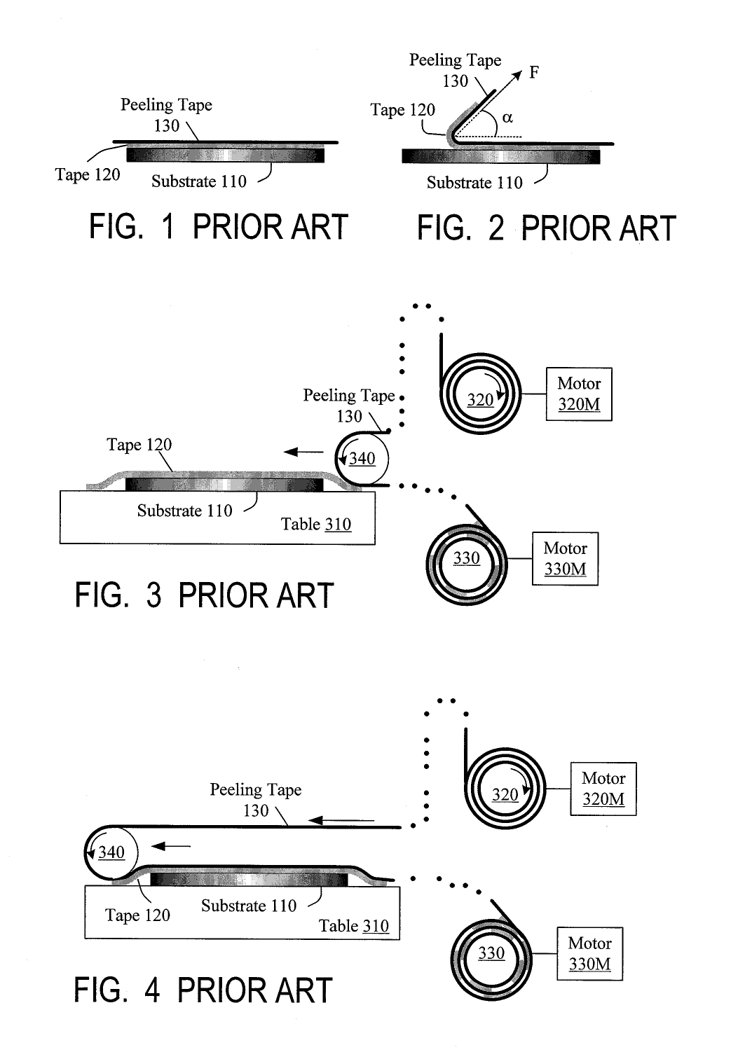

FIGS. 3-6 are side views of different stages of a prior art peeling operation.

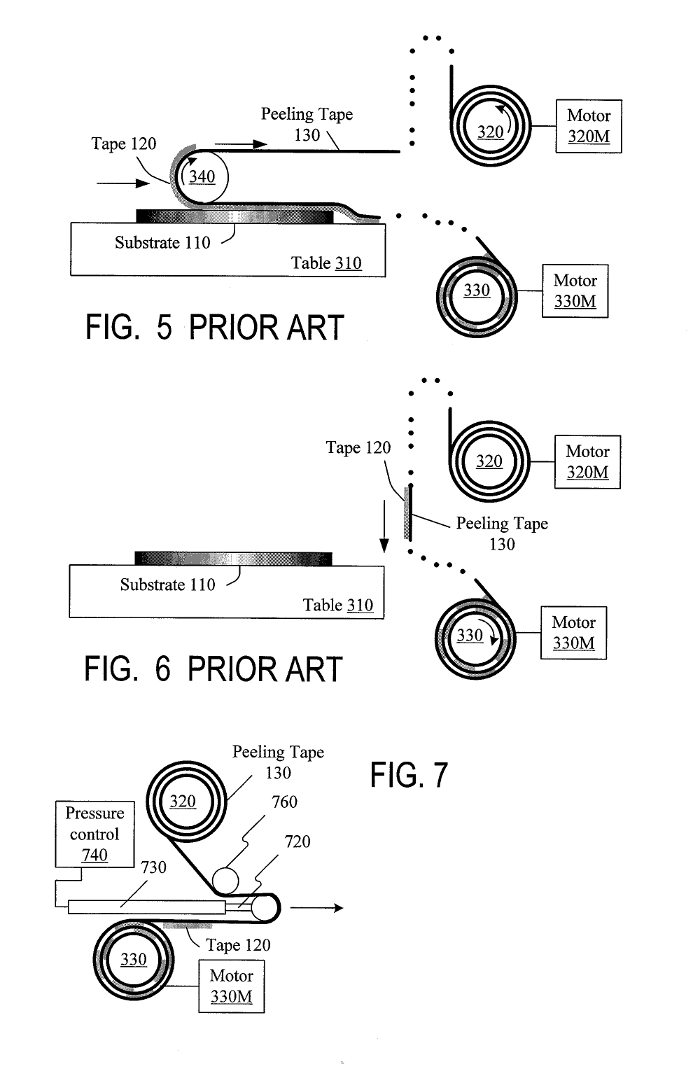

FIGS. 7-10 are side views of different stages of a peeling operation according to some embodiments of the present invention.

### DESCRIPTION OF SOME EMBODIMENTS

The embodiments described in this section illustrate but do not limit the invention. The invention is defined by the appended claims.

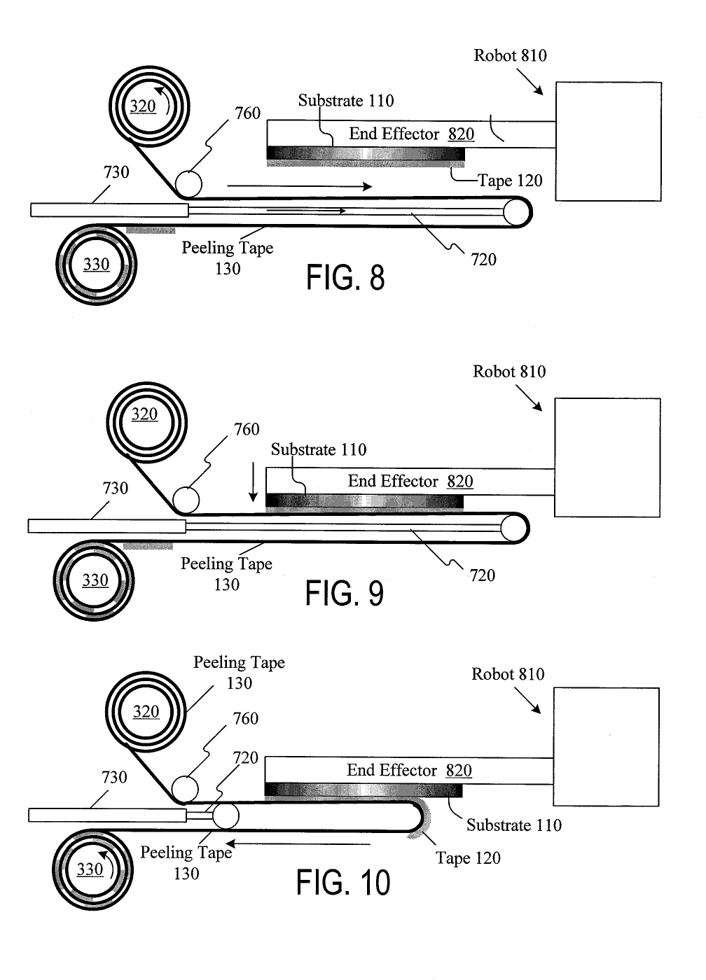

FIG. 7 illustrates a peeling apparatus according to some embodiments of the present invention. Peeling tape 130 runs around a knobbed end of a reciprocating shaft 720. Shaft 720 is set in motion using an air cylinder 730 which contains the shaft's other end (not shown). The shaft's position and motion are controlled by pressure control unit 740 which supplies the requisite air pressure to cylinder 730 in the region between the cylinder's left end and the shaft. Other mechanisms for moving the shaft 720 can also be used.

Also shown is a guiding roller 760 provided above the cylinder 730 and shaft 720 to guide the peeling tape. Other guiding mechanisms can also be used. The take-up roll 330 (“collector” roll) is operated by motor 330M. The supply roll 320 does not need a motor in the embodiment being described, but a motor such as 320M (FIG. 6) is provided in other embodiments.

The peeling tape has an adhesive surface facing away from shaft 720, and a non-adhesive surface facing the shaft.

Initially, the shaft 720 is withdrawn. Then the pressure inside the cylinder 730 is increased to extend the shaft out of the cylinder to a position shown in FIG. 8. The shaft's knobbed end pushes on the tape's non-adhesive surface to unwind the tape from supply 320 as the tape is prevented from unwinding from collector roll 330 (e.g. the collector roll 330 can be locked at this time, or can be generally constructed to rotate only in the tape-winding direction). In other embodiments, some of the tape is allowed to unwind from collector roll 330, but the tape portion above the shaft 720 is a fresh, unused section.

Robot 810 picks up the substrate 110 by an end effector 820. The substrate is held below the end effector, with tape 120 down. The end effector descends (FIG. 9) to press the tape 120 against the peeling tape section above the shaft 720, forming a good adhesive bond between the peeling tape and tape 120. The tape supply 320 can be locked at this time to maintain good tension in peeling tape 130. Tape collector 330 can also be locked.

The pressure in air cylinder 730 is reduced to withdraw the shaft 720 back into the cylinder (see FIG. 10). Tape collector 330 is rotated by motor 330M to pull on peeling tape 130, thus peeling the tapes 130, 120 off the substrate 110 at an acute angle a (FIG. 2).

The invention is not limited to the embodiments discussed above. Substrate 110 can be a semiconductor or non-semiconductor substrate. For example, in some embodiments, the substrate 110 is a carrier which is initially bonded to a semiconductor wafer (not shown) with double-sided adhesive tape 120 in order to strengthen the wafer in wafer thinning or other types of processing. Then the wafer is debonded, and the method of FIGS. 7-10 is performed to peel the tape 120 off the carrier. The carrier 110 can then be reused. Mechanisms other than air cylinders can be used to move the shaft 720. The shaft may have a large horizontal top surface to allow the substrate 110 to be pressed against the shaft's surface at the stage of FIG. 9 to achieve strong adhesion between the peeling tape 130 and tape 120. The shaft 720 can be replaced with a folding arm, or an inflatable tube, or a loop that goes around the tape 130 and pulls on the tape from the right side in the view of FIGS. 7-10, or with some other mechanism. The tape 130 may go through a hole in shaft 720 or a folding arm. Tape supply 320 does not have to be a roll, but can be a stack of folded tape or some other type of supply. Likewise, tape collector 330 does not have to be a roll. In some embodiments, both surfaces of tape 130 are non-adhesive; the adhesive bond between tapes 130, 120 is provided by the adhesive on tape 120. In other embodiments, tape 120 does not have an adhesive surface bonded to tape 130, and the bonding between the two tapes is provided by the adhesive on tape 130. In some embodiments, tape 120 is replaced with an adhesive layer which does not contain a tape.

Some embodiments of the present invention include a method for removing material from a substrate's surface, the method comprising: providing a tape (e.g. 130) extending from a tape supply to a tape collector along a first path (e.g. the path taken by tape 130 in FIG. 7); moving an object (e.g. shaft 720) from a first position (as in FIG. 7 for example) to a second position (e.g. FIG. 8) to cause the tape to move to a second path (e.g. as in FIG. 8) extending from the tape supply to the tape collector, the second path going around the object's edge (e.g. the knobbed end of shaft 720, or the tape 130 may be threaded through a hole in shaft 720 and thus go around the hole's inner edge (the shaft's edge inside the hole)) when the object is in the second position; bonding the material (e.g. 120) on the substrate's surface to the tape's section extending between the tape supply and the object's edge; withdrawing the object from the second position (e.g. as in FIG. 10) and peeling the tape off the substrate beginning at a location adjacent to a location which was occupied by the object's edge in the second position (e.g. the location at the right edge of substrate 110), wherein the tape is peeled off together with at least some of said material.

In some embodiments, the second path is longer than the first path, and moving the tape from the first path to the second path is accompanied by releasing a length of the tape from the tape supply.

In some embodiments, the peeling of the tape is performed as the tape moves towards the first path (e.g. in FIG. 10, the tape 130 is in the process of moving to the stage of FIG. 7).

In some embodiments, when the object is withdrawn, the tape is allowed to return to the first path and is forced into the first path (e.g. in FIG. 10, the tape is allowed to return to the path of FIG. 7 and is forced into that path by tape collector 330).

Other embodiments and variations are within the scope of the invention, as defined by the appended claims.

1. A method for removing material from a substrate's surface, the method comprising:
providing a tape extending from a tape supply to a tape collector along a first path;
moving an object from a first position to a second position to cause the tape to move to a second path extending from the tape supply to the tape collector, the second path going around the object's edge when the object is in the second position;
bonding the material on the substrate's surface to the tape's section extending between the tape supply and the object's edge;
withdrawing the object from the second position and peeling the tape off the substrate beginning at a location adjacent to a location which was occupied by the object's edge in the second position, wherein the tape is peeled off together with at least some of said material.

2. The method of claim 1 wherein moving the object from the first position to the second position comprises pushing on the tape with the object's edge.

3. The method of claim 2 wherein the object comprises a shaft reciprocating between the first and second positions, the object's edge being the shaft's end.

4. The method of claim 1 wherein the second path is longer than the first path, and moving the tape from the first path to the second path is accompanied by releasing a length of the tape from the tape supply.

5. The method of claim 1 wherein peeling the tape is accompanied by collecting a length of the tape by the tape collector.

6. The method of claim 1 wherein the peeling of the tape is performed as the tape moves towards the first path.

7. The method of claim 1 wherein said material comprises a tape adhesively bonded to the substrate.

8. The method of claim 1 wherein the tape is peeled off at an acute angle to the tape's portion on the substrate's surface.

9. The method of claim 1 wherein bonding of the material is performed after moving the tape to the second path.

10. The method of claim 9 wherein the bonding is performed when an end effector positions the substrate into a position in which the material contacts the tape, and the end effector continues to support the substrate after the placing.

11. The method of claim 1 wherein the bonding is an adhesive bonding with an adhesive on the tape or in the material.

12. The method of claim 1 wherein the bonding operation is performed with the substrate above the tape's section extending between the tape supply and the object's edge.

13. A method for removing material from a substrate's surface, the method comprising:
providing a tape extending from a tape supply to a tape collector along a first path;
moving an object from a first position to a second position to cause the tape to move to a second path extending from the tape supply to the tape collector, the second path going around the object's edge when the object is in the second position;
bonding the material on the substrate's surface to the tape's section extending between the tape supply and the object's edge;
moving the object to allow the tape to return to the first path and forcing the tape into the first path, the forcing causing the tape to be peeled off the substrate.

14. The method of claim 13 wherein moving the object from the first position to the second position comprises pushing on the tape with the object's edge.

15. The method of claim 14 wherein the object comprises a shaft reciprocating between the first and second positions, the object's edge being the shaft's end.

16. The method of claim 13 wherein the second path is longer than the first path, and moving the tape from the first path to the second path is accompanied by releasing a length of the tape from the tape supply.

17. The method of claim 13 wherein forcing the tape comprises collecting a length of the tape by the tape collector.

18. The method of claim 13 wherein said material comprises a tape adhesively bonded to the substrate.

19. The method of claim 13 wherein the tape is peeled off at an acute angle to the tape's portion on the substrate's surface.

20. The method of claim 13 wherein bonding of the material is performed after moving the tape to the second path.

21. The method of claim 13 wherein the bonding is an adhesive bonding with an adhesive on the tape or in the material.

22. The method of claim 13 wherein the bonding operation is performed with the substrate above the tape's section extending between the tape supply and the object's edge.

23. A method for removing material from a substrate's surface, the method comprising:
providing a tape extending from a tape supply to a tape collector;
releasing a tape portion from the tape supply;
positioning the substrate above the tape's section to bring the material on the substrate's surface into adhesive contact with the tape's section;
collecting the tape by the tape collector, the collecting comprising pulling on the tape to peel the tape and at least a portion of the material off the substrate's surface located at the bottom of the substrate.

24. An apparatus for removing material from a substrate's surface, the apparatus comprising:
a tape supply for supplying a tape;
a tape collector for collecting the tape;
an object, and a mechanism for moving the object between a first position and a second position, the object engaging the tape when moving from the first position to the second position, wherein the tape extends along a first path from the tape supply to the tape collector when the object is in the first position, and the tape moves from the first path to a second path when the object engages the tape in moving from the first position to the second position, the second path going around the object's edge;
a robot for bringing the material on the substrate's surface into contact with the tape's section extending between the tape supply and a location occupied by the object's edge when the object is in the second position, the tape's section being spaced from the first path;
wherein the mechanism for moving the object is arranged so that when the object moves from the second position to the first position and the tape collector collects the tape, the tape returns to the first path which is spaced from a position provided to the material by the robot when the material is in contact with the tape's section.

25. The apparatus of claim 24 wherein moving the object from the first position to the second position comprises pushing on the tape with the object's edge.

26. The apparatus of claim 24 wherein the object comprises a shaft reciprocating between the first and second positions, the object's edge being the shaft's end.

27. The apparatus of claim 24 wherein the second path is longer than the first path, and moving the tape from the first path to the second path is accompanied by releasing a length of the tape from the tape supply.

28. The apparatus of claim 24 wherein peeling the tape is accompanied by collecting a length of the tape by the tape collector.

29. The apparatus of claim 24 wherein the peeling of the tape is performed as the tape moves towards the first path.

30. The apparatus of claim 24 wherein the tape is peeled off at an acute angle to the tape's portion on the substrate's surface.

31. The apparatus of claim 24 wherein bringing of the material on the substrate's surface into contact with the tape's section is performed with the substrate being above the tape's section.
